(19) United States
(12) Patent Application Publication
(10) Pub. No.: US 2021/0348554 A1
(43) Pub. Date: Nov. 11, 2021

(54) Energy Recovery System

(71) Applicant: 1414 Degrees Limited, Adelaide (AU)

(72) Inventors: Matthew Johnson, Adelaide (AU); Nathan Levinson, Adelaide (AU)

(21) Appl. No.: 17/277,845

(22) PCT Filed: Sep. 23, 2019
(86) PCT No.: PCT/AU2019/000113

§ 371 Date: Mar. 19, 2021

(30) Foreign Application Priority Data
Sep. 21, 2018 (AU) 2018903567

(51) Int. Cl. F02C 3/00; F02C 6/00

(52) U.S. Cl. CPC F02C 3/00; F02C 6/00; F05D 2260/42; F05D 2220/76; F05D 2220/32

(57) ABSTRACT

An energy storage and retrieval system is disclosed. The system includes a heat generating layer for generating thermal energy based on combusting a combustible substance and a thermal energy storage layer located to receive thermal energy from the heat generating layer. The thermal energy storage layer includes a thermal energy storage material to store thermal energy. The system also includes a thermal energy retrieval layer thermally connectable to the thermal energy storage material and configurable to retrieve thermal energy from the thermal energy storage layer.

### CROSS-REFERENCE TO RELATED APPLICATIONS

This application is the United States national phase of International Application No. PCT/AU2019/000113 filed Sep. 23, 2019, and claims priority to Australian Provisional Patent Application No. 2018903567 filed Sep. 21, 2018, the disclosures of which are hereby incorporated by reference in their entireties.

### INCORPORATION BY REFERENCE

The following co-pending patent applications are referred to in the following description:
U.S. patent application Ser. No. 16/494,344 filed Mar. 23, 2018, which is the United States national phase of International Application No. PCT/AU2018/000043.

The content of these pending applications are hereby incorporated by reference in their entireties.

### BACKGROUND OF THE INVENTION

### Field of the Invention

The present disclosure relates to the storage and retrieval of energy. In a particular form, the present disclosure relates to the storage of thermal energy resulting from the burning of a combustible substance and the retrieval of this thermal energy for energy recovery purposes.

### Description of Related Art

In PCT Application No PCT/AU2018/000043 (U.S. patent application Ser. No. 16/494,344), the present applicant disclosed a thermal energy storage and retrieval system based on storing input electrical energy and employing a thermal energy storage material to store the thermal energy. This system is particularly suitable for the storing of excess electrical energy produced by renewable sources which may produce surplus electrical energy over and above either local requirements or that of any connected electrical grid. Another potential source of “excess” energy which otherwise would be wasted is the thermal energy obtained from the burning of a combustible substance generated by the decomposition of organic matter, for example a waste treatment system where the combustible substance is produced as a by-product of the primary waste treatment process.

In a one non-limiting example, a wastewater treatment plant digester system will produce as a by-product a combustible substance commonly known as digester gas or biogas. Digester gas is a combination of methane (CH₄) and carbon dioxide (CO₂) with a small percentage of other trace gases; Nitrogen, Oxygen and Hydrogen Sulphide (respectively N₂, O₂, H₂S). The gas composition can vary with the process and temperature (eg, seasonally) but a typical average is in the range of 50-75% (±5%) for CH₄ and 25-50% for CO₂. The CH₄ gas is a carbon-neutral renewable source of energy. A proportion of the produced digester gas may be used as fuel for a boiler or similar apparatus to generate heat to maintain the anaerobic digester of the wastewater treatment plant at the optimum temperature to aid in maximum gas generation. This then leaves a surplus of digester gas.

There are a number of options for potentially converting the surplus digester gas to useful energy. One option is the immediate burning of the digester gas in a reciprocating engine to generate electricity for local use or provision to the electrical grid; however, it is a feature of digester gases that they can contain hydrogen sulphide (H₂S) which when combusted in a reciprocating engine or boiler will then corrode the internal surface of the combustion chamber. The H₂S in digester gas may range between 50 to 10,000 ppm depending on the composition of the feed material introduced to the digester but gas engines will typically require this level to be no higher than 250 ppm due to the corrosive effects resulting from the presence of H₂S.

In addition, toxic concentrations of H₂S and/or SO₂ may also develop in the workplace upon burning of the digester gas. This then necessitates the pre-treating of the digester gas to reduce the level of H₂S prior to burning with a variety of absorption and adsorption or biological conversion processes being required which all add further processing complexity and expense to this process. As would be appreciated, an overarching issue of any system that converts waste gas to generate electricity is the ability to selectively dispatch any generated electricity to the electrical grid as this will be limited by the digester gas storage constraints and/or the high costs of storing electricity on site.

Given these disadvantages, another potential option to deal with digester gas as a potential energy source is to process the digester gas to produce renewable natural gas (RNG) or biomethane which is suitable for injection into existing natural gas networks. However, this process also has significant disadvantages in that refining of the digester gas is required and this involves large scale infrastructure investment which may not be justified based on the capacity of the wastewater treatment plant. A related option is to concentrate and store the digester gas either for use on site or offsite. However, as noted above, the entrained H₂S can cause corrosion of the pipeline infrastructure adding to maintenance costs and otherwise reducing plant lifetime for the infrastructure required for this process. The least favoured option is to simply flare the surplus digester gas, however, this is typically a last resort for utilities since the digester gas has to be pre-treated prior to flaring due to air quality regulations that strictly limit the dispersal of pollutants.

In view of the above considerations, there is a need for a method and system which can effectively and efficiently process, store and selectively dispatch the potential energy associated with the combustible substances generated as a by-product of waste treatment systems.

### SUMMARY OF THE INVENTION

In a first aspect, the present disclosure provides an energy storage and retrieval system comprising:
a heat generating layer for generating thermal energy based on combusting a combustible substance;
a thermal energy storage layer located to receive thermal energy from the heat generating layer, the thermal energy storage layer including a thermal energy storage material to store thermal energy; and
a thermal energy retrieval layer thermally connectable to the thermal energy storage material and configurable to retrieve thermal energy from the thermal energy storage layer.

In another form, the heat generating layer includes a combustible substance to thermal energy converter configured to generate a layer of thermal energy above the thermal energy storage layer.

In another form, the heat generating layer and the thermal energy storage layer are configured to together form a chamber having a chamber roof portion extending above the thermal energy storage layer.

In another form, the combustible substance to thermal energy converter is configured to generate a layer of thermal energy extending along the chamber roof portion to heat the thermal energy storage material.

In another form, the combustible substance to thermal energy converter is a regenerative heating system comprising at least one pair of regenerative burners operating in complementary burn and exhaust modes to generate thermal energy.

In another form, the chamber roof portion is substantially planar and a respective burner of the at least one pair of regenerative burners has a burner exit orifice configured to generate a substantially planar layer of thermal energy along the substantially planar roof portion.

In another form, the burner exit orifice comprises a bell shaped surface received into the chamber roof portion and wherein an outer rim of the bell shaped surface is configured to match the substantially planar roof portion.

In another form, the burner exit orifice includes one or more combustion air exit apertures spaced around the bell shaped surface to introduce a tangential flow of combustion air with respect to the bell shaped surface when the respective burner is operating in burn mode.

In another form, the heat generating layer, the thermal energy storage layer and the thermal energy retrieval layer form substantially parallel layers with respect to each other.

In another form, the thermal energy retrieval layer includes a heat conduction arrangement to conduct heat from the thermal energy storage layer and a fluid conveying arrangement for conveying heat transfer fluid to retrieve the heat conducted from the heat conduction arrangement.

In another form, the thermal energy storage material is silicon.

In another form, the thermal energy storage material is a eutectic material.

In another form, the thermal energy storage material is a silicon based eutectic material.

In another form, wherein the system operates in a storage mode, wherein a combustible substance is combusted in the heat generating layer to generate thermal energy to heat the thermal energy storage material of the thermal energy storage layer to store the thermal energy.

In another form, the thermal energy storage material changes phase on heating.

In another form, the system operates in a retrieval mode, wherein the thermal energy retrieval layer is configured to operate at a lower temperature than the thermal energy storage material to conduct heat from the thermal energy storage material.

In another form, the system operates in a storage/retrieval mode wherein a combustible substance is combusted in the heat generating layer to generate thermal energy to heat the thermal energy storage material of the thermal energy storage layer to store the thermal energy and wherein concurrently the thermal energy retrieval layer is configured to operate at a lower temperature than the thermal energy storage material to conduct heat from the thermal energy storage material.

In another form, the combustible substance is a gas generated by a waste treatment operation.

In a second aspect, the present disclosure provides a heat generating module for generating a substantially planar layer of thermal energy based on combusting a combustible substance, the heat generating module comprising:
a substantially planar mounting surface;
a regenerative heating system comprising at least one pair of regenerative burners mounted to the mounting surface, the at least one pair of regenerative burners operating in complementary burn and exhaust modes to generate thermal energy, wherein the at least one pair of regenerative burners include respective burner exit orifices configured to generate the substantially planar layer of thermal energy along the substantially planar mounting surface.

In another form, each of the respective burner exit orifices comprises a bell shaped surface received into the chamber roof portion and wherein an outer rim of the bell shaped surface is configured to match the substantially planar mounting surface portion.

In another form, each of the respective burner exit orifices includes one or more combustion air exit apertures spaced around the bell shaped surface to introduce a tangential flow of combustion air with respect to the bell shaped surface when the respective burner is operating in burn mode.

In a third aspect, the present invention provides a system for providing dispatchable electricity from a combustible substance, comprising:
the energy storage and retrieval system of the first aspect;
an energy recovery system configured to operate together with the energy storage and retrieval system, the energy recovery system comprising:
   a heat transfer fluid circulation arrangement to circulate a heat transfer fluid through the thermal energy retrieval layer of the energy storage and retrieval system to transfer heat energy to the heat transfer fluid;
   a gas turbine arrangement;
   a heat exchanger for transferring the heat energy in the heat transfer fluid retrieved from the energy storage and retrieval system to the gas turbine arrangement; and
   an electrical generator operatively connected to the gas turbine arrangement to generate the dispatchable electricity.

In another form, the gas turbine arrangement includes a gas turbine compressor and a gas turbine expander operating on a working fluid and wherein the heat exchanger transfers heat energy to the working fluid prior to input into the gas turbine expander.

In another form, the energy recovery system further includes a recuperator configured to capture heat energy from the gas turbine expander.

In another form, the recuperator heats the working fluid prior to entry into the heat exchanger.

In another form, the working fluid is air.

In another form, the heat transfer fluid is air.

In a fourth aspect, the present disclosure provides a method for storing and retrieving electrical energy employing the energy storage and retrieval system of the first aspect, comprising:
combusting the combustible substance in the heat generating layer;
storing the generated thermal energy by heating the thermal energy storage layer; and

retrieving the stored thermal energy by thermally connecting the thermal energy storage layer to the thermal energy retrieval layer.

### BRIEF DESCRIPTION OF DRAWINGS

Embodiments of the present disclosure will be discussed with reference to the accompanying drawings wherein:

FIG. 1 is a top perspective view of an energy storage and retrieval system in accordance with an illustrative embodiment;

FIG. 2 is a side view of the energy storage and retrieval system illustrated in FIG. 1;

FIG. 3 is a side sectional view through a vertical mid-plane of the energy storage and retrieval system illustrated in FIG. 1;

FIG. 4 is a top view of the energy storage and retrieval system illustrated in FIG. 1;

FIG. 5 is a horizontal sectional view through the thermal energy retrieval layer of the energy storage and retrieval system illustrated in FIG. 1;

FIG. 6 is an end view of the energy storage and retrieval system illustrated in FIG. 1;

FIG. 7 is a figurative sectional view of a regenerative burner in accordance with an illustrative embodiment;

FIG. 8 is a bottom perspective view of a heat generating module forming part of the heat generating layer illustrated in FIG. 1;

FIG. 9 is a side view of the heat generating module illustrated in FIG. 8;

FIG. 10 is a top view of the heat generating module illustrated in FIG. 8;

FIG. 11 is an end view of the heat generating module illustrated in FIG. 8;

FIG. 12 is an underside view of the heat generating module illustrated in FIG. 8;

FIG. 13 is a top view of a system for providing dispatchable electricity incorporating the energy storage and retrieval system illustrated in FIGS. 1 to 6 in accordance with an illustrative embodiment;

FIG. 14 is a side view of the dispatchable electricity system illustrated in FIG. 13; and

FIG. 15 is a system overview diagram of the dispatchable electricity system illustrated in FIGS. 13 and 14.

In the following description, like reference characters designate like or corresponding parts throughout the figures.

### DESCRIPTION OF THE INVENTION

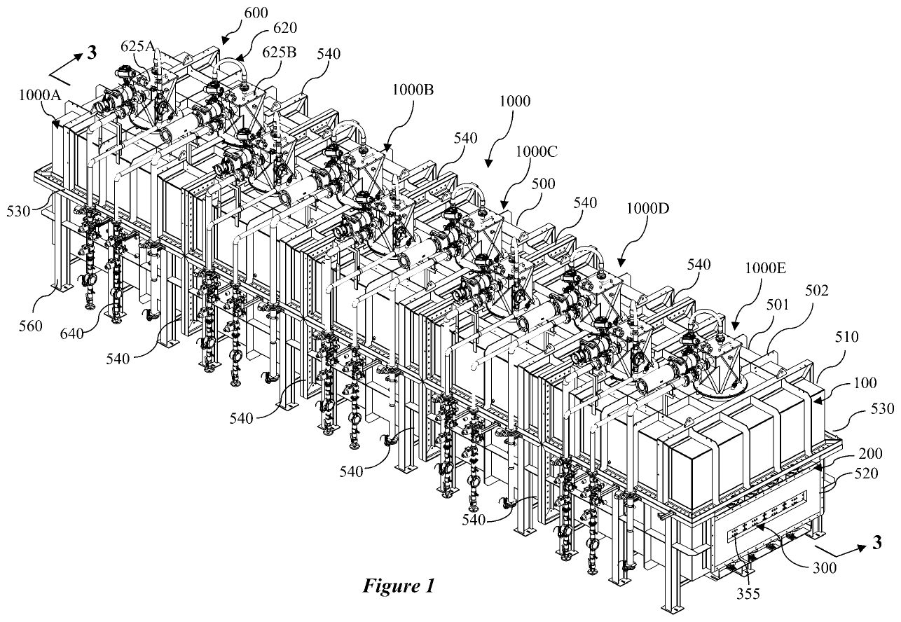

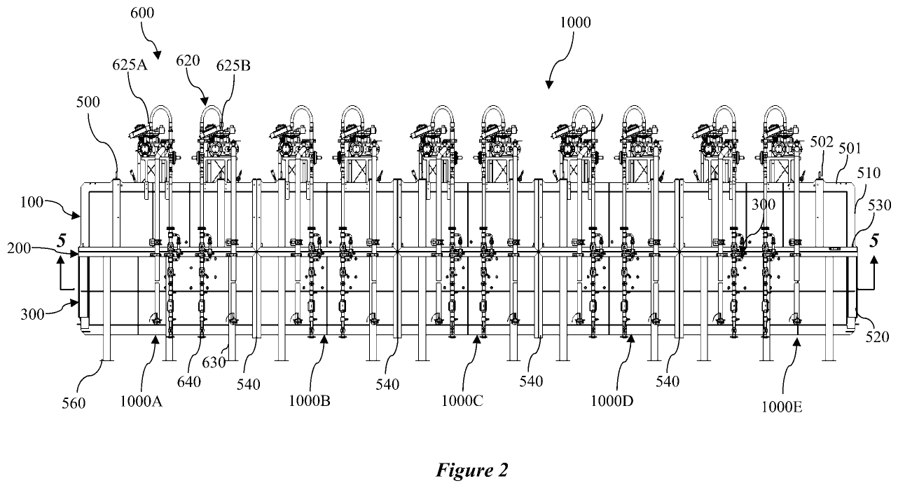

Referring now to FIGS. 1 to 6, there are shown various views of an energy storage and retrieval system 1000 according to an illustrative embodiment. In overview, energy storage and retrieval system 1000 comprises a heat generating layer 100 based on combusting a combustible substance, a thermal energy storage layer 200 and a thermal energy retrieval layer 300 for retrieving the stored thermal energy. In this embodiment, the thermal energy storage layer 200 includes a thermal energy storage material 200 which is located to receive thermal energy from heat generating layer 100 in order to store the thermal energy. The thermal energy retrieval layer 300 is thermally connected to the thermal energy storage material and is further configurable to retrieve thermal energy from the thermal energy storage layer 200.

On suitable heating from the heat generating layer 100, the thermal energy storage material 220 begins to change phase as the temperature of the thermal energy storage material transitions above a phase transition temperature of the material in order to store the thermal energy. When the thermal energy retrieval section 300 is configured to operate at a lower temperature than the thermal energy storage material, thermal energy will be released from the thermal energy storage material and conducted into the cooler thermal energy retrieval layer 300 for retrieval.

The energy storage and retrieval system 1000 may be operable in three modes. The first mode is a storage mode where the heat generating layer 100 generates heat by burning or combusting a combustible substance in the process causing heating and eventual phase change of the thermal energy storage material 220 to store the thermal energy. In this mode, the thermal energy retrieval layer 300 is configured such that there is no substantive temperature difference between it and the thermal energy storage material. In another example, the thermal energy retrieval layer 300 may be selectively thermally isolated or insulated from the thermal energy storage layer 200 to prevent the transfer of thermal energy between these sections.

The second mode is a retrieval mode, where the thermal energy retrieval layer 300 is configured to be thermally connected to thermal energy storage layer 200 and to operate at a lower temperature than the thermal energy storage material 220 and thermal energy will be conducted from the thermal energy storage material for retrieval in the thermal energy retrieval layer 300.

The third mode is a combined storage/retrieval mode where the heat generating layer 100 is operable to heat the thermal energy storage material in the thermal energy storage layer 200 and the thermal energy retrieval layer 300 is configured to be thermally connected and operate at a lower temperature than the thermal energy storage material 220 to conduct thermal energy for retrieval.

In this example, energy storage and retrieval system 1000 includes a generally elongate rectangular prism or box assembly structure 500 which in this example is supported by a plurality of support members or feet 560 which function to maintain the assembly structure 500 at an elevated position with respect to the ground. The assembly structure 500 is formed of a suitable high temperature heat resistant material having an external steel skin 501 incorporating strengthening ribs 502. In one example, the refractory material is comprised of a suitable ceramic fibre board material. As would be appreciated, the exact configuration of the heat resistant structure of the assembly structure 500 may be modified according to the expected operating temperature and required external temperature of the assembly structure 500.

As discussed in the Applicant's co-pending PCT Application No PCT/AU2018/000043 (U.S. patent application Ser. No. 16/494,344), the design requirements of assembly structure 500 are similar to those of a high temperature oven, kiln or furnace where an internal operating temperature and an external “skin” temperature suitable for the environment are specified. In this embodiment, the desired external surface temperature of assembly structure 500 is approximately 50° C. but this external surface temperature should be kept as low as possible as this reflects the amount of achieved thermal insulation.

In this illustrative embodiment, energy storage and retrieval system 1000 comprises five modules 1000A, 1000B, 1000C, 1000D and 1000E, in turn comprising respective end modules 1000A and 1000E and intermediary modules 1000B, 1000C and 1000D. The modules are joined together at their edges by vertically extending bolt and flange arrangements 540 to form combined assembly structure 500. As would be apparent, the size and capacity of energy storage and retrieval system 1000 may be varied by changing the number of intermediary modules as required. Each individual module is in turn formed from an upper housing section 510 and a lower housing section 520 which are joined together by respective horizontally outwardly extending bolt and flange arrangements 530. As would be appreciated, individual upper housing sections 510 or lower housing sections 520 of the assembly structure 500 may be removed from the assembled energy storage and retrieval system 1000 to obtain access as required.

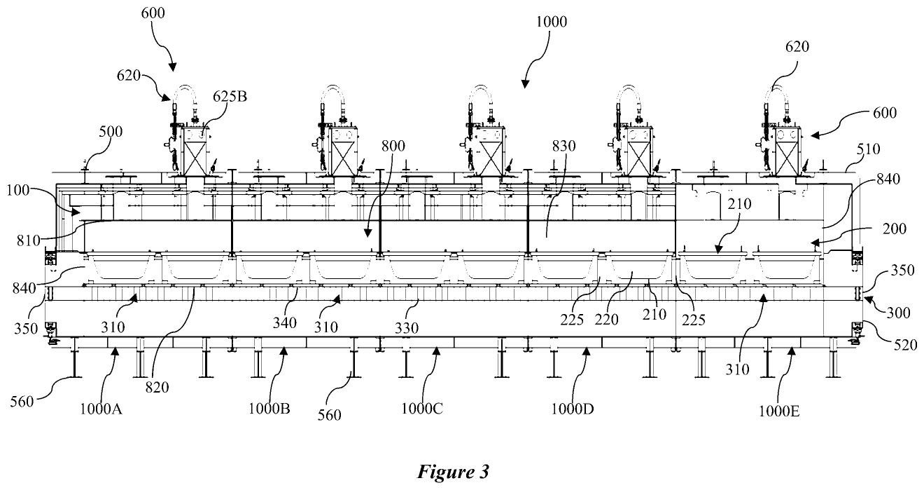

In this illustrative embodiment, the heat generating layer 100 and the thermal energy storage layer 200 are configured to together form a substantially sealed internal chamber 800 within housing 500 where the chamber 800 is formed as a generally elongate rectangular prism cavity similar in configuration to that of housing 500. As would be appreciated, the size and configuration of internal chamber 800 may be varied in line with requirements. In this example, internal chamber 800 includes a substantially planar chamber roof portion 810, a substantially planar chamber floor portion 820, chamber end wall portions 840 and chamber side wall portions 830 as best shown in the sectional view of FIG. 3. In this embodiment, the chamber roof portion 810 and chamber floor portion 820 are substantially parallel to each other.

Thermal energy storage layer 200 includes one or more containers 210 containing a thermal energy storage material 220 located in internal chamber 800 and which are supported by chamber floor portion 820. Thermal energy storage material 220 changes phase on heating by heat generating layer 100 of the thermal energy storage material 220 and transitions above a phase transition temperature in order to store thermal energy and can release thermal energy when the thermal energy storage material 220 is thermally connected to the cooler thermal energy retrieval layer 300 when system 1000 is operating in the second retrieval mode or combined storage/retrieval mode.

In this example, where the thermal energy storage material 220 is selected to be silicon, containers 210 are configured to have an open-ended or open-topped inverted rectangular frustum of a pyramid or truncated pyramid-shape. In this example, container 210 further incorporates rounded edges and is formed from heat resistant or refractory materials such as a high-density nitride bonded silicon carbide. In other examples, the container may be formed from other grades of silicon carbide, quartz, alumina, mullite or graphite which as would be appreciated are all materials operable at temperatures above 700° C. This container geometry is configured to reduce the stress on the container during solidification of the silicon as it releases thermal energy as the tapered walls encourage or promote the silicon to expand upwards instead of outwards and as a result reduces the expansive forces on the container walls.

In this embodiment, each of the containers is supported by the chamber floor portion 820 which in this example is formed from a suitable heat conducting material in order to transfer heat from the containers 210 into the thermal energy retrieval layer 300. Each container is separated from adjacent containers 210 by a gap 225. In one embodiment, the chamber floor portion 820 is formed from planar graphite plates. In other examples, suitable conducting members may be configured to extend from the chamber floor portion 820 into the thermal energy retrieval layer 300 to further assist in the transfer of thermal energy. In one embodiment, the containers 210 include a sacrificial liner or membrane formed of a material such as graphite card or titanium foil that protects the container 210 from the thermal storage material 220 at the high operating temperatures. In another example, containers 210 further include a removable graphite sheet cover that assists in reducing the potential oxidation of the silicon and further confines the silicon material to container 210.

While the above embodiment has been described where the thermal energy storage material 220 is silicon, other phase change materials may also be adopted. In one example, the thermal energy storage material 220 is a eutectic material. In a further example, the eutectic material is a silicon based eutectic material. Examples of silicon based eutectic materials include, but are not limited to:
Aluminium-Silicon-Nickel (Al—Si—Ni) eutectic having a melting point of approximately 1079° C., this material having a stable oxide layer and further which does not expand on solidification;
Iron-Silicon (Fe—Si) eutectic comprising in this example of 50% silicon and having a corresponding melting point of approximately 1202° C.; and
Copper-Silicon (Cu—Si) eutectic comprising in this example of 45% silicon and having a melting point of approximately 1200° C.

In another embodiment, thermal energy storage layer 200 includes an inert gas flushing or purging arrangement configured to introduce a flow of inert gas above and around the thermal energy storage material 220 to displace other gases such as exhaust gases from heat generating layer 100. In one example, the inert gas used is nitrogen but alternatively other inert gases such as helium or argon or inert gas mixtures may be used depending on requirements.

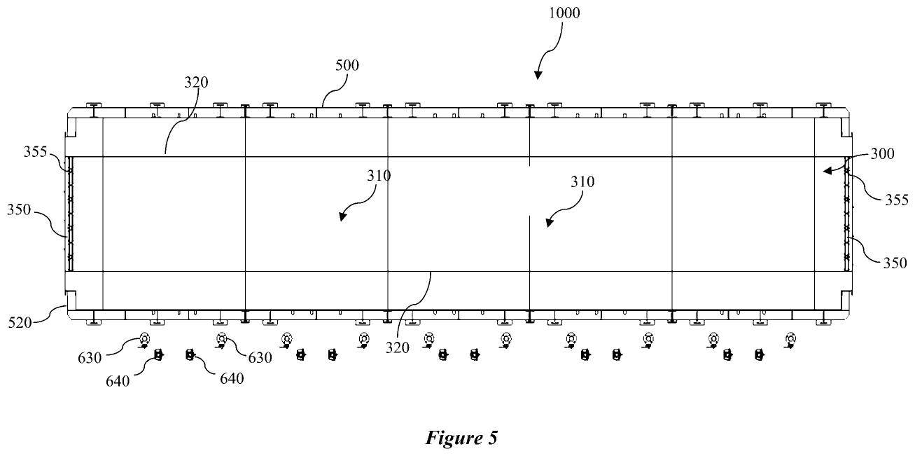

Referring now in particular to FIGS. 3 and 5, there are shown vertical and sectional views of energy storage and retrieval system 1000 depicting the thermal energy retrieval layer 300 which in this embodiment comprises a heat conducting arrangement in the form of the planar graphite plates that forms both the chamber floor portion 820 of internal chamber 800 and the channel roof portion 340 of a fluid conveying arrangement for conveying the heat transfer fluid which also forms part of the thermal energy retrieval layer 300. In this example, the heat transfer fluid conveying arrangement is in the form of a unitary elongate channel or duct 310 that extends from one end of the assembly structure 500 to the other opposed end under the chamber floor portion 820 of internal chamber 800 upon which the containers 210 are mounted and supported. Channel 310 further includes a channel floor portion 330 and channel side wall portions 320.

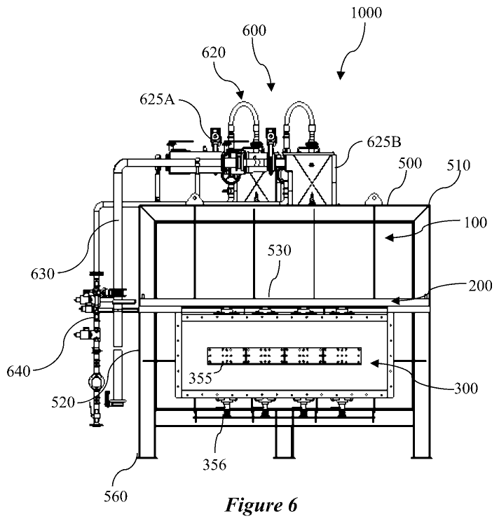

Channel 310 further includes two open ends 350 corresponding to the ends of assembly structure 500 which are sealable by a valving arrangement 355 which in this embodiment comprises a plurality of butterfly valves that extend across the open ends 350 and which are controllable to open or close channel 310 by electrical actuators 356 (see FIG. 6) as required. In this manner, movement or circulation of the heat transfer fluid may be prevented in order to thermally isolate the energy storage and retrieval system 1000 from any energy recovery system.

In one embodiment, channel 310 includes a plurality of turbulence inducing members to improve the transfer of heat from the thermal energy storage layer 200 by increasing consistent heat transfer across the whole sectional volume of channel 310. As would be appreciated, the configuration of the turbulence inducing members may be adopted depending on the geometry of the thermal energy retrieval layer 300 and examples are given in co-pending PCT Application No PCT/AU2018/000043 (U.S. patent application Ser. No. 16/494,344) referred to above.

As would be appreciated, while in this embodiment the fluid conveying arrangement is formed as a unitary linear channel extending between the ends of the assembly structure 500, other types of configurations may be adopted as required. In one example, the heat transfer fluid conveying arrangement may consist of a channel or duct that is U-shaped with both the channel entry and exit ports located on the same side of assembly structure 500. In another example, the channel may adopt a serpentine path below chamber 800.

In this embodiment, heat generating layer 100 includes a combustible substance to thermal energy converter 600 in the form of regenerative heating system 620 that introduces or generates a layer of thermal energy above the thermal energy storage layer 200. In this example, regenerative heating system is configured to generate a layer of thermal energy extending along or within the substantially planar roof portion 810 of internal chamber 800 above thermal energy storage layer 200 which will function to heat thermal energy storage material 220 located in the containers 210 which in this example are supported by the substantially planar chamber floor portion 820 of chamber 800.

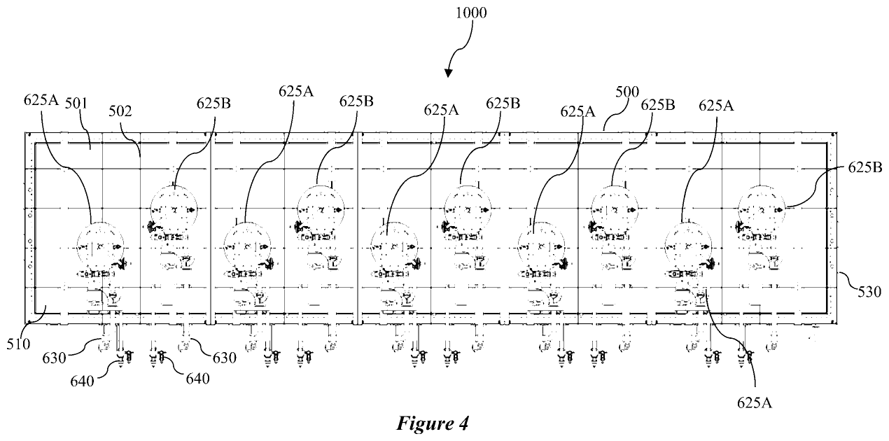

Regenerative heating system 620 in this embodiment comprises one or more pairs of controlled burners 625A, 625B forming part of the upper housing section 510 of housing 500 of energy storage and retrieval system 1000 (as best seen in FIG. 4) and operable to generate heat from roof portion 810 of internal chamber 800 directed to the thermal energy storage layer 200.

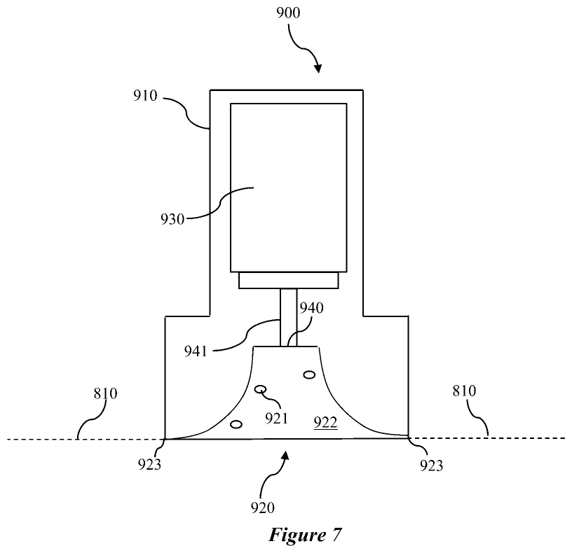

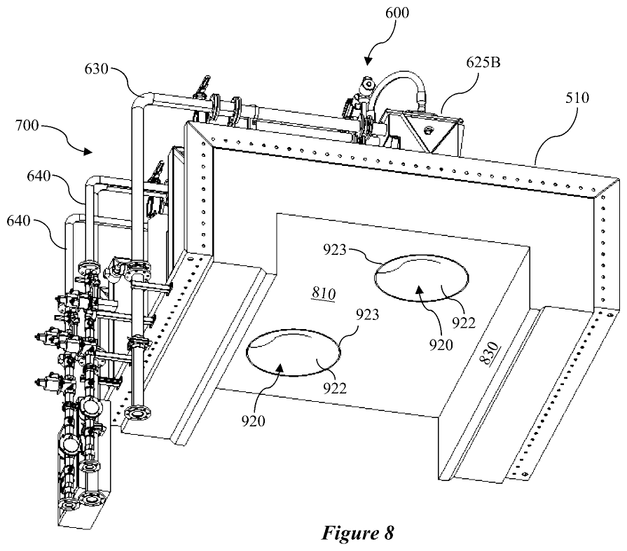

Referring now to FIG. 7, there is shown a sectional figurative overview of a regenerative burner 900 of the type employed in the present disclosure (eg, burners 625A, 625B) configured to produce a substantially planar layer of thermal energy. Burner 900 includes an outer housing 910 that houses the various air and gas supply and exhaust conduits as well as the ignition components. Burner 900, in this example includes a burner exit orifice 920 formed from a suitable refractory material which comprises a bell shaped or inverted non-regular conical surface 922 whose outer rim 923 is shaped and flared outwardly gradually to match the planar chamber roof portion 810 of chamber 800 (as can be seen in FIG. 8).

In the surface 922 of burner exit orifice 920 there is disposed one or more combustion air exit apertures 921 which are configured to introduce a tangential flow of combustion air into the burner exit orifice 920 and which function to deploy the thermal energy in a planar layer along the channel roof portion 810 as the tangent curve of the bell shaped surface 922 conforms to the planar surface of the channel roof portion 810 at the outer rim 923 of the exit orifice 920. Burner 900 further includes a centrally disposed gas exit aperture 940 for the supply of combustible gas through supply/exhaust port 941.

Regenerative burner 900 further includes a regenerator element 930 formed in this example of honeycomb matrix of ceramic material which functions to store heat from any hot gas that passes through the regenerator element 930. In this manner, regenerator element 930 functions as a thermal reservoir to store heat when exhausting gas through the regenerator element.

Regenerative burner 900 operates in both a burn mode and an exhaust mode. In the burn mode, combustible gas is supplied to central gas exit aperture 940 through supply/exhaust port 941 and ignited to burn as a central flame driven by the combustible gas. Simultaneously, combustion air is supplied into the burner exit orifice 920 through one or more air exit apertures 921 after it has passed through regenerator element 930 and this generates a tangential flow of heated combustion air which follows the bell shaped surface 922 and then exits the burner exit orifice 920 in a direction substantially parallel to tangential direction at the rim 923 of the exit orifice 920.

In exhaust mode, the supply of combustible gas and combustion air is stopped and exhaust gas arising from the paired regenerative burner (eg, burner 625B for burner 625A, and vice versa) is sucked through regenerator element 930 via exit orifice 920 and supply/exhaust port 941. Note that in the overall system, the pairing between burners may be any configuration that results in half of the burners being in burn mode and the other half being in exhaust mode, eg for the ten burner system illustrated, non-limiting examples of heat generation would include alternating pairings of burners, or five burners in sequence operating in burn mode and five burners in sequence operating in exhaust mode. The regenerator element 930 functions to store heat which then heats the combustion air when the regenerative burner 900 transitions to burn mode again. In this example, the heating of the combustion air assists in achieving temperatures of greater than 1300° C. required to capture enough energy from the combustible gas to cause a phase transition in the thermal energy storage material 220.

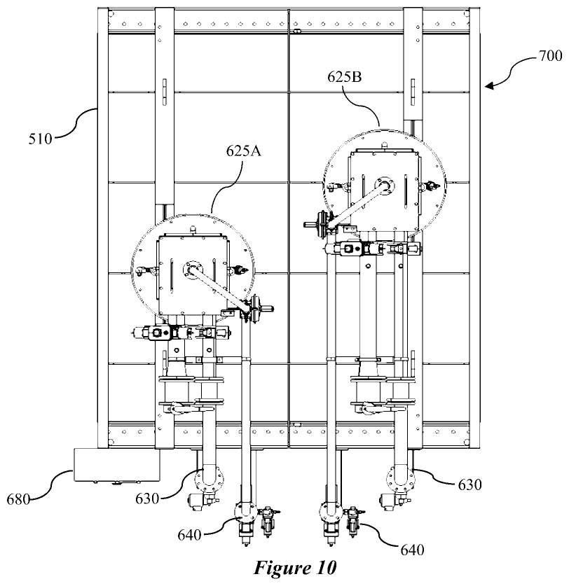

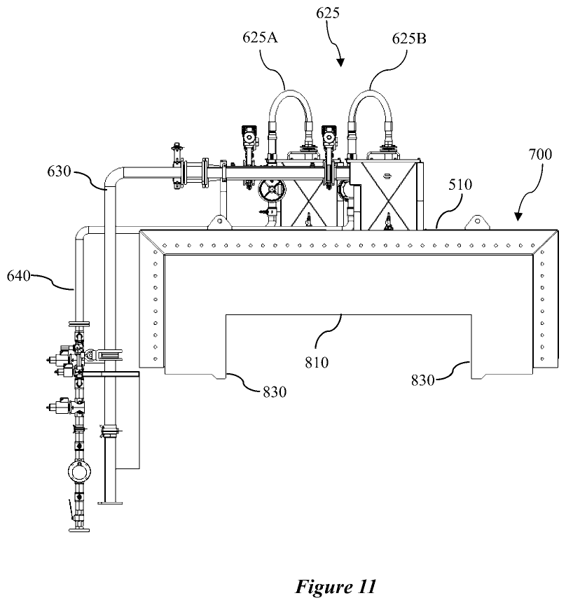

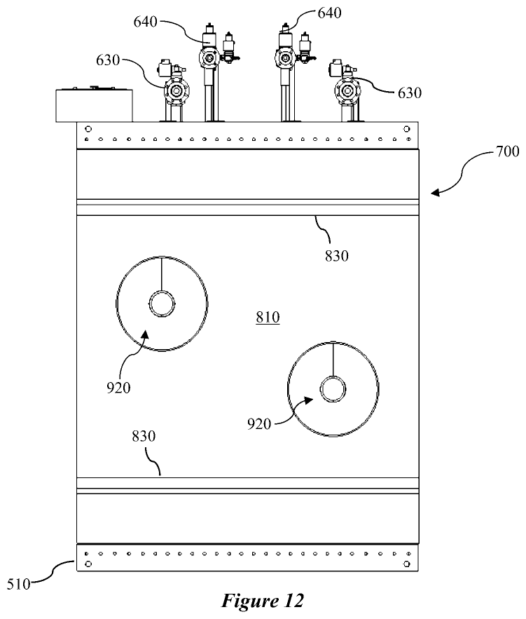

Referring now to FIGS. 8 to 12, there are shown various detailed views of a heat generating module 700 for generating thermal energy based on a combustible substance which forms part of the heat generating layer 100 illustrated in FIGS. 1 to 7. In this example, heat generating module 700 is formed in the upper housing section 510 of a module of the assembly structure 500. As can be seen in FIGS. 8 to 12, heat generating module 700 incorporates a pair of regenerative burners 625A, 625B as has been described previously which are received in the roof portion of the heat generating module 700 and which on assembly will form the chamber roof portion 810 of assembly structure 500. As best seen in FIG. 12, burners 625A, 625B are positioned offset in both directions with respect to each other resulting in the respective burner exit orifices 920 being arranged in diagonal configuration over this portion of the chamber roof portion 810.

This diagonal configuration increases the distance between the burners 625A, 625B in each pairing compared to a parallel configuration, and decreases the likelihood of short-circuits between adjacent paired burners operating in burn mode and exhaust mode. A short-circuit between paired burners may result in unwanted thermal energy loss from the system in the exhaust gas. The diagonal configuration also solves spatial constraint issues arising from insufficient room to locate burners 625A, 625B in parallel.

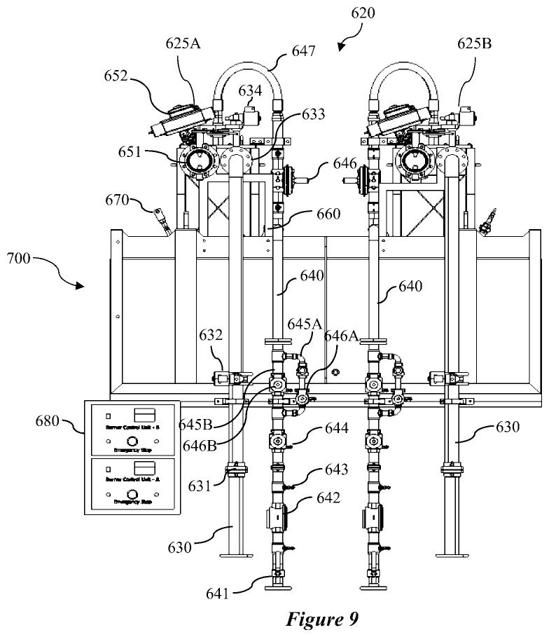

Referring now to FIG. 9, and in particular to the operation of burner 625A which includes a combustion air supply line 630 and a gas supply line 640. Air supply line 630 from the supply side includes a flow measuring device 631 in the form of an orifice plate and a flow control valve 632 and is connected to air input orifice 633 of burner 625A with the supply of combustion air into burner 625A controlled by combustion air switching valve 634. Exhaust output line (not shown) is connected to gas exhaust flange 651 which is controlled by exhaust switching valve 652. As would be appreciated, the various sensors, valves, igniters and other components are interfaced to an electronic control system 680 which functions to control the regenerative burner system as described below.

Digester gas supply line 640 from the supply side includes a manual isolation valve 641, a filter 642, a flow measuring device 643 in the form of an orifice plate and a safety solenoid valve 644. Gas supply line 640 then includes a branch network consisting of a first gas supply branch 645A to provide a reduced start up flow rate in order to start burner 625A by closing solenoid 646B and opening solenoid 646A. The branch network can then be switched over to second gas supply branch 645B in order to provide the full flow rate once burner 625A is operating at full capacity by opening solenoid 646B and closing solenoid 646A.

Following branch network, digester gas supply line 640 includes a gas flow control valve 646 which includes a proportional controller that is controlled by a pressure signal from the air supply line 630 in that when the air supply shuts off to burner 625A then the gas supply to burner 625A will also be shut off. Following gas flow control valve 646, the gas supply line 640 includes a braided flexi gas line coupling 647 connecting gas flow control valve 646 to burner 625A.

In order to ignite burner 625A, start up gas flow to burner is commenced by actuating first gas supply branch 645A of gas supply line 640. The igniter 660 is then energised which will generate an ignition spark and the presence of a flame is then determined by UV flame detector 670. Assuming that burner 625A has ignited, then the first gas supply branch 645A is closed and the second gas supply branch 645B and combustion air switching valve 634 are opened resulting in the burner 625A operating at full burning capacity.

As referred to above, burners 625A, 625B operate together as a regenerative heating system 620 where each burner is identical but controlled to operate in the following manner Once burner 625A has been ignited and is operating at full capacity, burner 625B functions to suck the hot exhaust gas emitted by burner 625A in the process heating up its regenerator. The temperature of the exhaust gas that has passed through the regenerator is monitored and will progressively increase indicating that the regenerator has reached its thermal energy storage capacity at which stage the combustion air (and supply gas) for burner 625A is shut off and burner 625B goes through the ignition control sequence and following ignition the combustion air entering burner 625B will be preheated prior to combustion as it passes through the regenerator of burner 625B.

The cycle then repeats, except that burner 625A functions to suck hot exhaust gas resulting from the operation of burner 625B which in turn heats up the regenerator element of burner 625A. Once the exhaust temperature of burner 625A reaches the required temperature indicating that the regenerator element is fully heated then burner 625B is shut off and burner 625A is ignited. In this manner, burners 625A, 625B operate in combination to generate thermal energy. In the present example, regenerative burners operate on a duty cycle of approximately 20 to 30 seconds for each burner.

In this illustrative example, the combustible or supply gas to burners 625A, 625B is a digester gas originating from a wastewater treatment plant. As would be appreciated, the present invention may be employed with any other combustible gas such as other biogases arising as part of waste treatment operations. Alternatively, the combustible gas may be from a standard gas supply source such as natural gas.

A heat generating layer 100 in accordance with the present disclosure functions to provide a substantially planar “layer” of thermal energy which in this example is substantially parallel to the thermal energy storage layer as a result ensuring consistent and uniform heating of the thermal energy storage material 220 during the energy storage mode which avoids the development of hot and cold spots throughout the chamber, reduces the impact of thermal expansion, and thereby improves the stability and longevity of the chamber and its contents.

As would be appreciated, other burner arrangements that function to generate a layer of thermal energy above the thermal energy storage layer may be adopted. In one example, regenerative burners or other types of burners may be mounted in the chamber end or side wall portions and having burner exit orifices located proximate to the roof portion above the thermal energy storage layer. In this manner, these burners will function to deploy the thermal energy laterally in a planar layer extending along, in this case, the planar channel roof portion. In other embodiments, the burners may be deployed both in the roof, side and/or end wall portions and be configured to together generate a layer of thermal energy above the thermal energy storage layer.

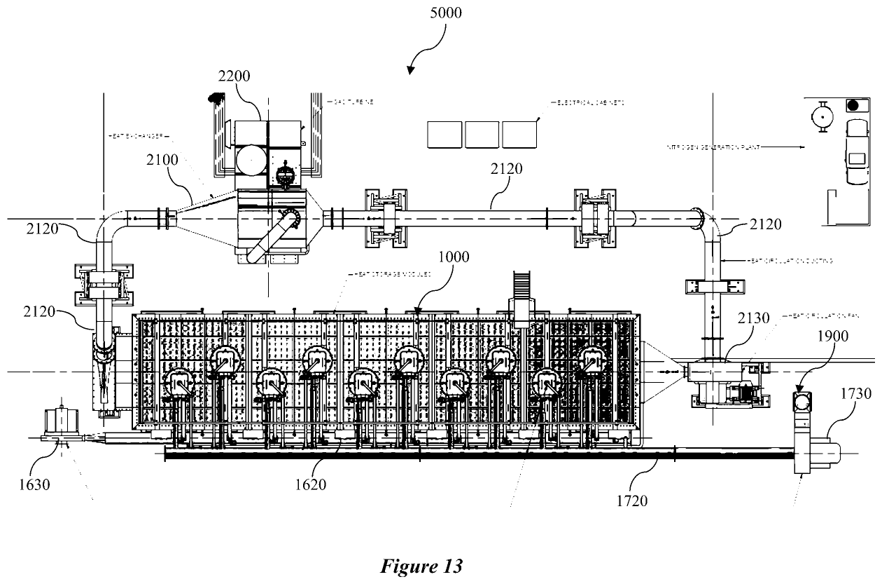

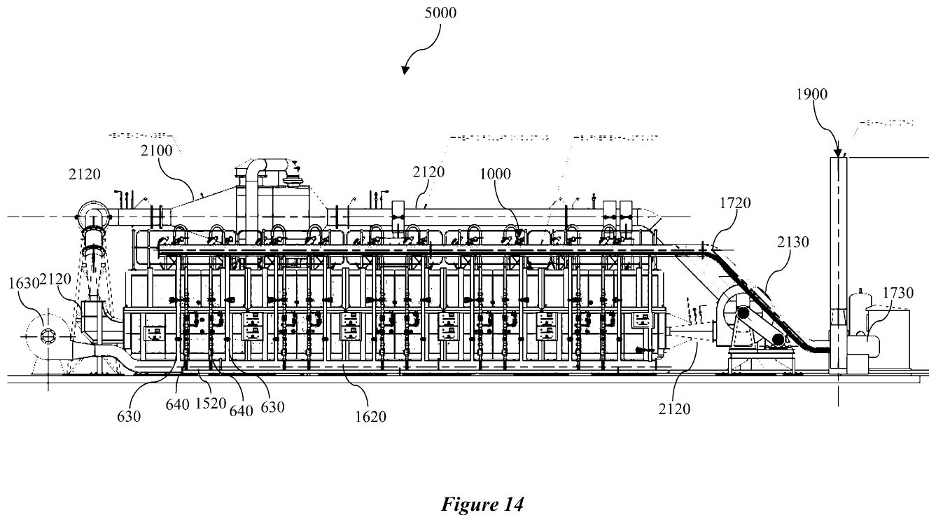

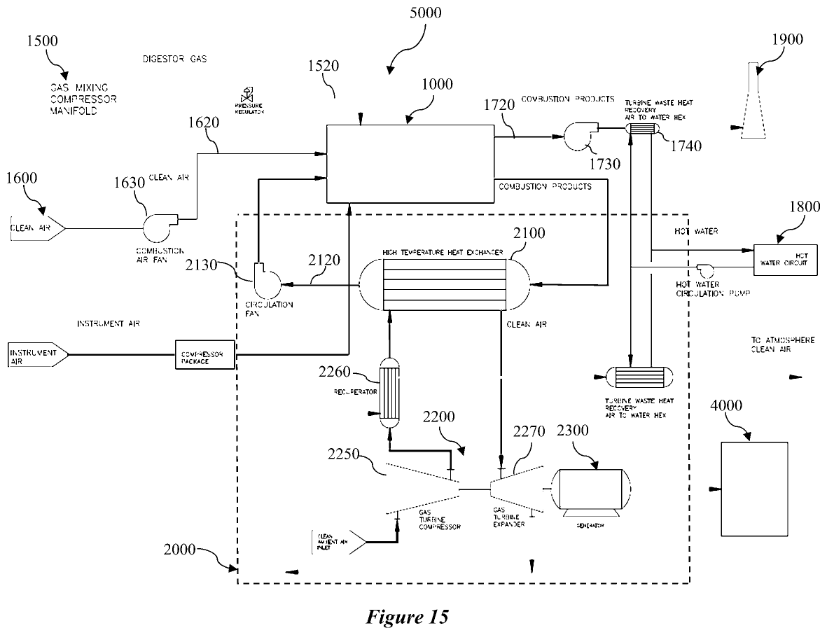

Referring now to FIGS. 13 and 14, there are shown top and side views of a system 5000 for providing dispatchable electricity incorporating the energy storage and retrieval system 1000 illustrated in FIGS. 1 to 6 according to an illustrative embodiment. Shown in FIG. 15 is a system overview diagram of the dispatchable electricity system 5000 illustrated in FIGS. 13 and 14.

In this example, dispatchable electricity system 5000 comprises the energy storage and retrieval system 1000 and further includes an energy recovery system 2000 (as best shown in FIG. 15) comprising a heat transfer fluid circulation arrangement 2120 to circulate a heat transfer fluid through the thermal energy retrieval layer 300 of system 100 to transfer heat energy to the heat transfer fluid, a gas turbine arrangement 2200 consisting of a turbine compressor 2250 and a turbine expander 2270 operable on a working fluid, a heat exchanger 2100 for transferring heat energy in the heat transfer fluid retrieved from system 1000 to the working fluid of the gas turbine arrangement 2200, and an electrical generator 2300 for converting the rotational energy of the turbine arrangement 2200 into electrical energy which may be dispatched to the electrical grid 4000 on activation of energy recovery system 2000. In this example, energy recovery system 2000 further includes a recuperator 2260 to capture heat energy from turbine expander 2270. In this example, the combustible substance is digester gas which is sourced from waste water treatment plant 1500.

In the first mode, where the energy storage and retrieval system 1000 is operating to store energy, system 1000 receives digester gas by gas supply piping arrangement 1520 at a pressure of approximately 7 kPA and combustion air from clean air source 1600 by a fan arrangement 1630 that delivers the combustion air by combustion air supply piping arrangement 1620 at a capacity of approximately 200 m³·hr⁻¹ and a pressure of approximately 12 kPA. In this example, gas supply piping arrangement 1520 is connected to the respective gas supply lines 640 of the regenerative burners and combustion air supply piping arrangement 1620 is similarly connected to the combustion air supply lines 630 of the regenerative burners (eg, see FIG. 9).

The exhaust gas is evacuated from system 1000 by exhaust piping arrangement 1720 which is driven by fan arrangement 1730 which has an operating pressure of approximately −10 kPA and a capacity of 3750 m³·hr⁻¹ with the operating temperature of the exhaust gas at approximately 180° C. after passing through the regenerator element exhausting through gas exhaust flange 651 of each burner (eg, see FIG. 9). In one example, the exhaust air from system 1000 is passed through an optional heat exchanger 1740 to recover heat which is input into a hot water circuit 1800 before the exhaust gas is finally exhausted to atmosphere by exhaust stack 1900.

In the second or third modes, where the energy storage and retrieval system 1000 is operating in energy retrieval mode or combined energy storage/retrieval mode, the energy recovery system 2000 is connected to system 1000 by circulating a heat transfer fluid through thermal energy retrieval layer 300 to raise the temperature of the heat transfer fluid and then employing this high temperature heat transfer fluid to drive a combined turbine 2200 and electrical generator 2300 arrangement.

In this example, the heat transfer fluid is air which is circulated through energy storage and retrieval system 1000 by circulation arrangement in the form of ducting assembly 2120 and fluid circulating means in the form of a circulation fan 2130 which delivers air at a temperature of approximately 550° C. and a flow rate of approximately 2.5 kg·s⁻¹ to the input end of system 1000. Following passage through the thermal energy retrieval layer 300 the air then exits at an elevated temperature of approximately 900° C. for input into heat exchanger 2100 to drive turbine arrangement 2200.

In this example, gas turbine arrangement 2200 includes a gas turbine compressor 2250 which in this embodiment employs air as the working fluid. In this example, the ambient air has a flow rate of approximately 2.5 kg·s⁻¹ which raises the temperature to 200° C. The air from gas turbine compressor 2250 is then fed into recuperator 2260 which is also fed the exhaust gas from the counterpart gas turbine expander 2270 of gas turbine arrangement 2200. Following passage through recuperator 2260 the temperature of the air is approximately 500° C. where it is then fed into heat exchanger 2100 which is driven by the energy storage and retrieval system 1000 and which further raises the temperature of the air in the gas turbine circuit to approximately 800-900° C. with a flow rate of approximately 2 kg·s⁻¹ and a pressure of 380 kPA at which point it is then introduced into drive gas turbine expander 2270 which in turn drives electrical generator 2300 to generate electricity which may be dispatched to the electricity grid 4000. As referred to above, the exhaust from gas turbine expander 2270, which is at a temperature of approximately 600° C., is employed in recuperator 2260 to raise the temperature of the air that is output from gas turbine compressor 2250.

As would be appreciated, dispatchable electricity system 5000 allows an operator to determine when to convert stored thermal energy into dispatchable electricity without requiring the storage of combustible gas or alternatively the storage of electricity that may have been generated by directly burning of the combustible gases generated by a waste treatment operation. In addition, the high temperature operation of energy storage and retrieval system 1000, involving the use of regenerative burners is beneficial as compared to burning the digester gas in an engine to generate electricity because the cost and complexity of pre-treating the digester gas for the engine, eg scrubbing H₂S, is eliminated by the much higher 1350° C. combustion temperature in the system 5000. At this high temperature the chemical bonds in most of the digester gas components break down, eliminating H₂S from the combustion byproducts, and delivering the attendant environmental and safety benefits.

As would be appreciated, other types of energy recovery systems may be coupled to energy storage and retrieval system 1000 not necessarily directed to generating dispatchable electricity. These other types of energy recovery systems include those that primarily generate dispatchable heat eg hot water boilers and heat recovery steam generators.

Throughout the specification and the claims that follow, unless the context requires otherwise, the words “comprise” and “include” and variations such as “comprising” and “including” will be understood to imply the inclusion of a stated integer or group of integers, but not the exclusion of any other integer or group of integers.

The reference to any prior art in this specification is not, and should not be taken as, an acknowledgement of any form of suggestion that such prior art forms part of the common general knowledge.

It will be appreciated by those skilled in the art that the invention is not restricted in its use to the particular application described. Neither is the present invention restricted in its preferred embodiment with regard to the particular elements and/or features described or depicted herein. It will be appreciated that the invention is not limited to the embodiment or embodiments disclosed, but is capable of numerous rearrangements, modifications and substitutions without departing from the scope of the invention as set forth and defined by the following claims.

1. An energy storage and retrieval system comprising:
a heat generating layer for generating thermal energy based on combusting a combustible substance;
a thermal energy storage layer located to receive thermal energy from the heat generating layer, the thermal energy storage layer including a thermal energy storage material to store thermal energy; and
a thermal energy retrieval layer thermally connectable to the thermal energy storage material and configurable to retrieve thermal energy from the thermal energy storage layer.

2. The energy storage and retrieval system of claim 1, wherein the heat generating layer includes a combustible substance to thermal energy converter configured to generate a layer of thermal energy above the thermal energy storage layer.

3. The energy storage and retrieval system of claim 2, wherein the heat generating layer and the thermal energy storage layer are configured to together form a chamber having a chamber roof portion extending above the thermal energy storage layer.

4. The energy storage and retrieval system of claim 3, wherein the combustible substance to thermal energy converter is configured to generate a layer of thermal energy extending along the chamber roof portion to heat the thermal energy storage material.

5. The energy storage and retrieval system of claim 2, wherein the combustible substance to thermal energy converter is a regenerative heating system comprising at least one pair of regenerative burners operating in complementary burn and exhaust modes to generate thermal energy.

6. The energy storage and retrieval system of claim 5, wherein the chamber roof portion is substantially planar and a respective burner of the at least one pair of regenerative burners has a burner exit orifice configured to generate a substantially planar layer of thermal energy along the substantially planar roof portion.

7. The energy storage and retrieval system of claim 6, wherein the burner exit orifice comprises a bell shaped surface received into the chamber roof portion and wherein an outer rim of the bell shaped surface is configured to match the substantially planar roof portion.

8. The energy storage and retrieval system of claim 7, wherein the burner exit orifice includes one or more combustion air exit apertures spaced around the bell shaped surface to introduce a tangential flow of combustion air with respect to the bell shaped surface when the respective burner is operating in burn mode.

9. The energy storage and retrieval system of claim 1, wherein the heat generating layer, the thermal energy storage layer and the thermal energy retrieval layer form substantially parallel layers with respect to each other.

10. The energy storage and retrieval system of claim 1, the wherein the thermal energy retrieval layer includes a heat conduction arrangement to conduct heat from the thermal energy storage layer and a fluid conveying arrangement for conveying heat transfer fluid to retrieve the heat conducted from the heat conduction arrangement.

11. The energy storage and retrieval system of claim 1, wherein the thermal energy storage material is silicon.

12. The energy storage and retrieval system of claim 1, wherein the thermal energy storage material is a eutectic material.

13. The energy storage and retrieval system of claim 12, wherein the thermal energy storage material is a silicon based eutectic material.

14. The energy storage and retrieval system of claim 1, wherein the system operates in a storage mode, and wherein a combustible substance is combusted in the heat generating layer to generate thermal energy to heat the thermal energy storage material of the thermal energy storage layer to store the thermal energy.

15. The energy storage and retrieval system of claim 14, wherein the thermal energy storage material changes phase on heating.

16. The energy storage and retrieval system of claim 14, wherein the system operates in a retrieval mode, and wherein the thermal energy retrieval layer is configured to operate at a lower temperature than the thermal energy storage material to conduct heat from the thermal energy storage material.

17. The energy storage and retrieval system of claim 16, wherein the system operates in a storage/retrieval mode in which a combustible substance is combusted in the heat generating layer to generate thermal energy to heat the thermal energy storage material of the thermal energy storage layer to store the thermal energy and wherein concurrently the thermal energy retrieval layer is configured to operate at a lower temperature than the thermal energy storage material to conduct heat from the thermal energy storage material.

18. The energy storage and retrieval system of claim 1, wherein the combustible substance is a gas generated by a waste treatment operation.

19. A method for storing and retrieving electrical energy employing the energy storage and retrieval system of claim 1, comprising:
combusting the combustible substance in the heat generating layer;
storing the generated thermal energy by heating the thermal energy storage layer; and
retrieving the stored thermal energy by thermally connecting the thermal energy storage layer to the thermal energy retrieval layer.

20. A system for providing dispatchable electricity from a combustible substance, comprising:
the energy storage and retrieval system of claim 1;
an energy recovery system configured to operate together with the energy storage and retrieval system, the energy recovery system comprising:
a heat transfer fluid circulation arrangement to circulate a heat transfer fluid through the thermal energy retrieval layer of the energy storage and retrieval system to transfer heat energy to the heat transfer fluid;
a gas turbine arrangement;
a heat exchanger for transferring the heat energy in the heat transfer fluid retrieved from the energy storage and retrieval system to the gas turbine arrangement; and
an electrical generator operatively connected to the gas turbine arrangement to generate the dispatchable electricity.

21. The system according to claim 20, wherein the gas turbine arrangement includes a gas turbine compressor and a gas turbine expander operating on a working fluid and wherein the heat exchanger transfers heat energy to the working fluid prior to input into the gas turbine expander.

22. The system according to claim 21, wherein the energy recovery system further includes a recuperator configured to capture heat energy from the gas turbine expander.

23. The system according to claim 22, wherein the recuperator heats the working fluid prior to entry into the heat exchanger.

24. The system of claim 21, wherein the working fluid is air.

25. The system of claim 20, wherein the heat transfer fluid is air.
